(19) United States
(12) Patent Application Publication
(10) Pub. No.: US 2007/0008061 A1
(43) Pub. Date: Jan. 11, 2007

(54) Electric plug

(76) Inventor: Chi-Wen Chen, Taipei City (TW)

Correspondence Address: LADAS & PARRY, 5670 WILSHIRE BOULEVARD, SUITE 2100, LOS ANGELES, CA, 90036-5679, US

(21) Appl. No.: 11/174,855

(22) Filed: Jul. 5, 2005

(51) Int. Cl. H01H 85/02; H01H 85/46; H01H 85/30

(52) U.S. Cl. 337/187

(57) ABSTRACT

An electric plug includes a housing which has front and rear walls, a fuse-receiving space, and a first aperture provided in the front wall. First and second conductive members are mounted inside the housing and project outwardly from the front wall. The second conductive member has a first fuse contact part extending into the fuse-receiving space. First and second wire conductors extend into the housing through the rear wall. The second wire conductor has a second fuse contact part extending into the fuse-receiving space. A first fuse member is disposed in the fuse-receiving space and contacts first and second fuse contact parts of the second conductive member and wire conductor. A cover plate covers the first aperture and has two insert holes for outward extension of the first and second conductive members.

### BACKGROUND OF THE INVENTION

1. Field of the Invention

The invention relates to an electric plug, more particularly to an electric plug incorporating a fuse.

2. Description of the Related Art

In the prior art, to ensure safety in using electric plugs, electric plugs are provided with fuses there inside. In order to permit fuse replacement, some electric plugs are provided with a housing which can be disassembled by using a tool such as a screw driver to detach screws for removing the fuse from the housing. Some electric plugs have a detachable cover with which a fuse can be attached to or detached from a plug housing. This invention is to provide a new electric plug construction which is convenient to disassemble and replace a fuse.

### SUMMARY OF THE INVENTION

Therefore, the main object of the present invention is to provide an electric plug to overcome the aforesaid drawbacks associated with the prior art.

Accordingly, an electric plug of the present invention comprises a housing, a conductor unit, a wire, a first fuse member and a cover plate.

The housing includes a front wall and a rear wall, a fuse-receiving space, and a first aperture provided in the front wall and communicated with the fuse-receiving space.

The conductor unit includes first and second conductive members mounted inside the housing and projecting outwardly from the front wall. The second conductive member has a first fuse contact part extending into the fuse-receiving space.

The wire includes first and second wire conductors, and extends into the housing through the rear wall. The second wire conductor has a second fuse contact part extending into the fuse-receiving space.

The first fuse member is disposed in contact with the first and second fuse contact parts in the fuse-receiving space.

The cover plate is disposed removably over the front wall and covers the first aperture. The cover plate has two insert holes for outward extension of the first and second conductive members therethrough.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a preferred embodiment of an electric plug according to the present invention;

FIG. 2 is a schematic sectional view of the preferred embodiment;

FIG. 3 is an exploded perspective view of the preferred embodiment illustrating that an inner frame is inserted into a housing;

FIG. 4 is the same view as FIG. 2 but with the cover plate being inserted into the housing; and

FIG. 5 is the same view as FIG. 4, but with hooks being disengaged from engaging slots.

### DETAILED DESCRIPTION OF THE PREFERRED EMBODIMENT

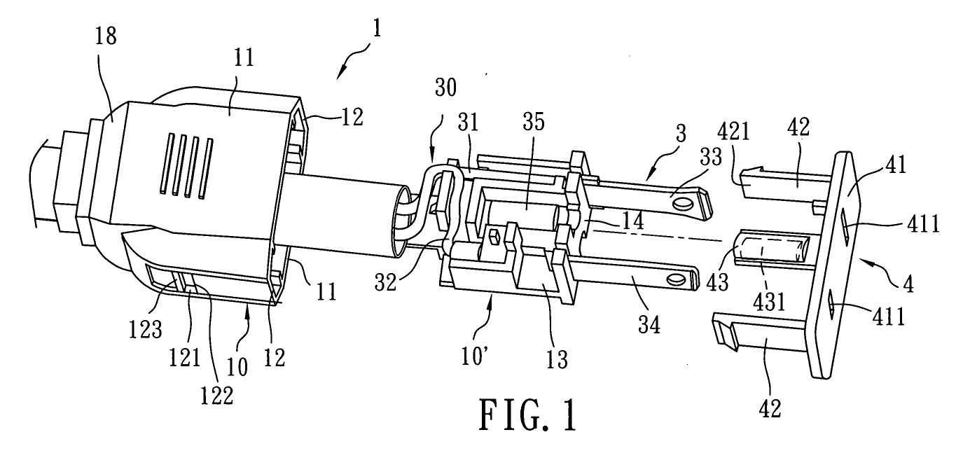

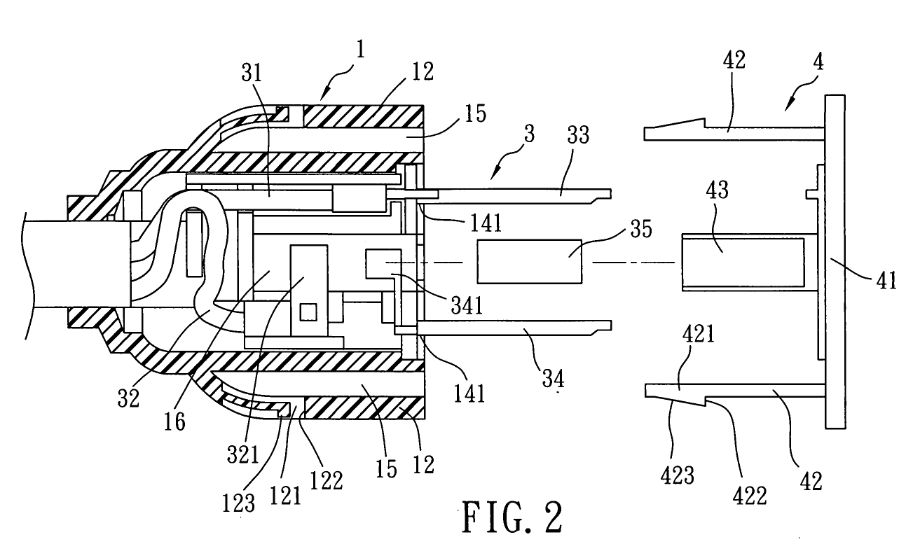

Referring to FIGS. 1, 2 and 3, the preferred embodiment of an electric plug is shown to comprise a housing 1, a conductor unit 3, a wire 30, a first fuse member 35, a second fuse member 36, and a cover plate 41.

The housing 1 is composed of an outer shell 10 and an inner frame 10′ mounted inside the outer shell 10. The inner frame 10′ inserted into the outer shell 10 defines a front wall 14 for the housing 1. Accordingly, the housing 1 includes the front wall 14, a rear wall 18, a fuse-receiving space 16, and a first aperture 142 provided in the front wall 14 and communicated with the fuse-receiving space 16. A pair of mounting slots 141 are formed in the front wall 14 in a spaced apart relationship.

The housing 1 further includes two first lateral walls 12 connected between the front and rear walls 14, 18, two prong-receiving holes 15 each provided adjacent to one of the first lateral walls 12, and two engaging slots 121 formed respectively in the first lateral walls 12 and communicated with the respective prong-receiving holes 15. Each of the engaging slots 121 includes a front end formed with an engaging face 122, and a resilient press part 123 extended from a rear end of the corresponding engaging slot 121. The resilient press part 123 extends into the corresponding engaging slot 121.

The housing 1 further includes two second lateral walls 11 connected between the front and rear walls 14, 18 and between the first lateral walls 12, and a partition wall 13 disposed between and extending substantially along the second lateral walls 11. The fuse-receiving space 16 is formed between the partition wall 13 and one of the second lateral walls 11. The housing 1 further includes a storage space 17 formed between the partition wall 13 and the other one of the second lateral walls 11, and a second aperture 143 formed in the front wall 14 and communicated with the storage space 17.

The first fuse member 35 is disposed within the fuse-receiving space 16 through the first aperture 142, and the second fuse member 36 is disposed in the storage space 17 through the second aperture 143.

The conductor unit 3 includes first and second conductive members 33, 34 that are mounted inside the housing 1 and projects outwardly through the respective mounting slots 141 of the front wall 14. The second conductive member 34 has a first fuse contact part 341 extending into the fuse-receiving space 16.

The wire 30 extends into the housing 1 through the rear wall 18, and includes first and second wire conductors 31, 32 connected electrically to the first and second conductive members 33, 34, respectively. The second wire conductor 32 has a second fuse contact part 321 extending into the fuse-receiving space 16.

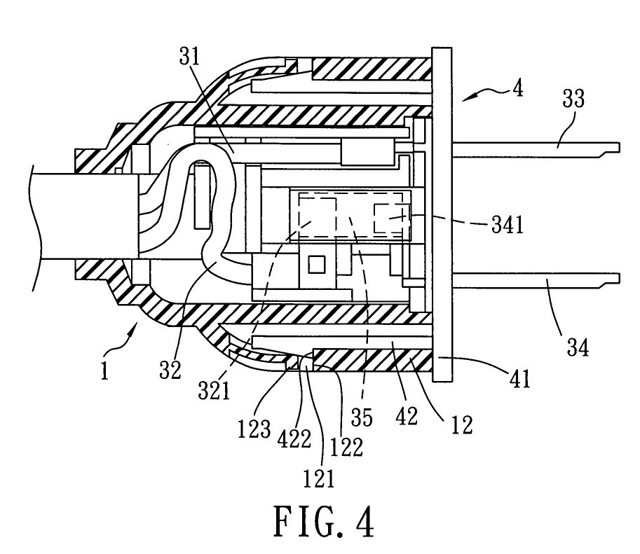

As shown in FIG. 4, the first and second fuse contact parts 341, 321 are spaced apart from each other within the fuse-receiving space 16. The first fuse member 35 bridges and contacts the first and second fuse contact parts 341, 321 in the fuse-receiving space 16.

The cover plate 41 is disposed removably on the front wall 14 and covers the first and second apertures 142, 143. The cover plate 1 has two insert holes 411 for outward extension of the first and second conductive members 33, 34, and a leg member 43 which projects into the fuse-receiving space 16 from the cover plate 41 through the first aperture 142 and which has a fuse-positioning groove 431. The cover plate 41 further includes two prongs 42 which project into the prong-receiving holes 15, respectively, and each of which has a hook 421 to engage a corresponding one of the engaging slots 121. Each of the hooks 421 includes an engaging side 422 parallel to the cover plate 41, and an inclined guiding side 423 extending from the engaging side 422 and inclined inwardly toward a direction away from the cover plate 41.

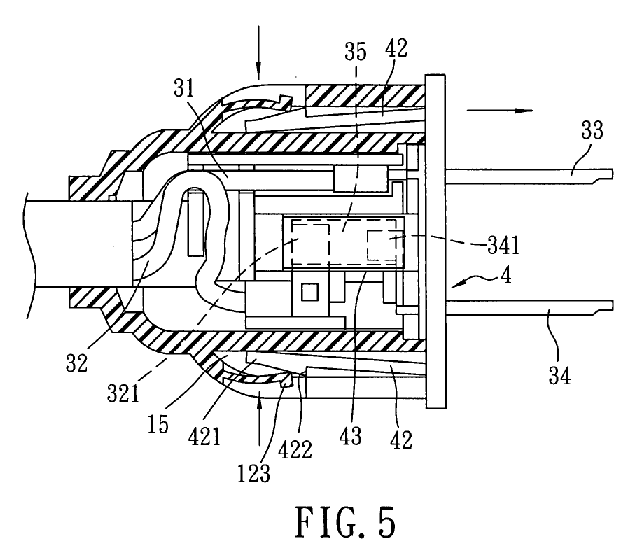

Referring to FIG. 5 in combination with FIG. 4, in assembly, the first and second wire conductors 31, 32 and the first and second conductive members 33, 34 are first mounted on the housing 1 in such a manner that the first fuse contact part 341 of the second conductive member 34 and the second fuse contact part 321 of the second wire conductor 32 are spaced apart from each other. Next, the second fuse member 36 is disposed in the storage space 17. Then, the housing 1 is turned upside down such that the fuse-receiving space 16 opens downward, and the cover plate 41 is also turned upside down such that the leg member 43 projects upward. The first fuse member 35 is placed in the fuse-positioning groove 431 of the leg member 43 in such a manner that half of the first fuse member 35 is exposed outwardly of the fuse-positioning groove 431.

When the cover plate 41 is inserted into the housing 1 until the engaging sides 422 of the prongs 42 move past the engaging faces 122 of the respective engaging slots 121, the cover plate 41 is secured to the housing 1 and covers the first and second apertures 142, 143. At this time, the exposed part of the first fuse member 35 has both ends abutting against the first and second fuse contact parts 341, 321 so that the electric plug is in an electrically conducting relationship with a power source. At this time, the resilient press parts 123 extend outwardly of the prongs 42.

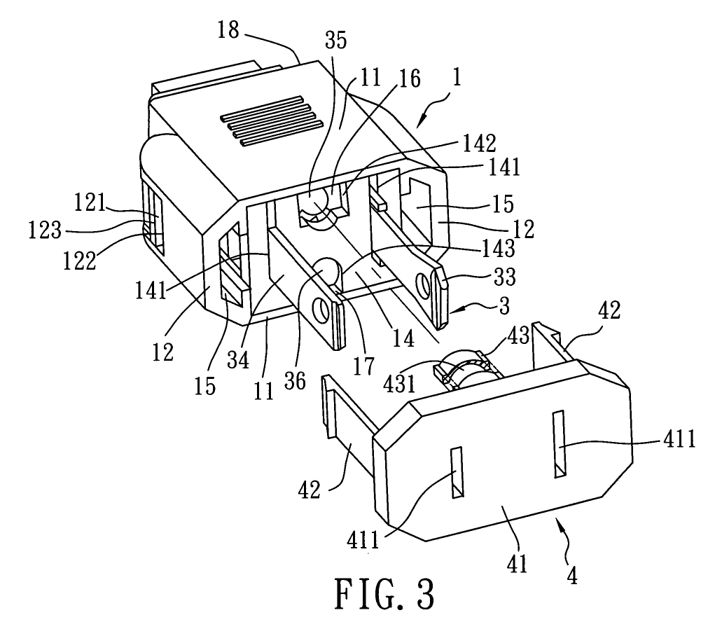

Referring once again to FIGS. 3 and 5, when the first fuse member 35 is to be replaced, first, the resilient press parts 123 are pressed inward to disengage the engaging sides 422 of the prongs 42 from the engaging faces 122 of the first lateral walls 12 so as to permit the cover plate 41 to be detached from the housing 1. Then, the second fuse member 36 is removed from the storage space 17, and the cover plate 41 is turned upside down to remove the first fuse member 35 from the fuse-positioning groove 431. Finally, the second fuse member 36 is placed in the fuse-positioning groove 431, and the cover plate 41 is re-inserted into the housing 1.

In sum, since the cover plate 41 may be pulled out from the housing 1 by pressing the hooks 421 of the prongs 42 through the resilient press parts 123 for replacement of the first fuse member 35, it is not necessary to use any tool to disassemble the housing 1. Moreover, due to the storage space 17 provided in the housing 1, the housing 1 may be provided with a spare fuse, i.e. the second fuse member 36. The electric plug according to the present invention is therefore convenient for replacement of a used fuse.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. An electric plug comprising:
a housing including a front wall and a rear wall, a fuse-receiving space, and a first aperture provided in said front wall and communicated with said fuse-receiving space;
a conductor unit including first and second conductive members mounted inside said housing and projecting outwardly from said front wall, said second conductive member having a first fuse contact part extending into said fuse-receiving space;
a wire including first and second wire conductors, and extending into said housing through said rear wall, said second wire conductor having a second fuse contact part extending into said fuse-receiving space;
a first fuse member disposed in contact with said first and second fuse contact parts in said fuse-receiving space; and
a cover plate disposed removably over said front wall and covering said first aperture, said cover plate having two insert holes for outward extension of said first and second conductive members.

2. The electric plug as claimed in claim 1, wherein said cover plate includes a leg member which projects into said fuse-receiving space from said cover plate through said first aperture and which has a fuse-positioning groove.

3. The electric plug as claimed in claim 1, wherein said housing further includes two first lateral walls connected between said front and rear walls, two prong-receiving holes each provided adjacent to one of said first lateral walls, and two engaging slots formed respectively in said first lateral walls, said cover plate further including two prongs which project into said prong-receiving holes, respectively, and each of which has a hook to engage a corresponding one of said engaging slots.

4. The electric plug as claimed in claim 3, wherein each of said first lateral walls further includes a resilient press part extending into one of said engaging slots and operable to press and release a corresponding one of said prongs.

5. The electric plug as claimed in claim 2, wherein said housing further includes two first lateral walls connected between said front and rear walls, two prong-receiving holes each provided adjacent to one of said first lateral walls, and two engaging slots formed respectively in said first lateral walls, said cover plate further including two prongs which project into said prong-receiving holes, respectively, and each of which has a hook to engage a corresponding one of said engaging slots.

6. The electric plug as claimed in claim 5, wherein said housing further includes two second lateral walls connected between said front and rear walls and between said first lateral walls, and a partition wall disposed between and extending substantially along said second lateral walls, said fuse-receiving space being formed between said partition wall and one of said second lateral walls, said housing further including a storage space formed between said partition wall and the other one of said second lateral walls, and a second aperture formed in said front wall and communicated with said storage space.

7. The electric plug as claimed in claim 6, further comprising a second fuse member disposed in said storage space.
